(19) United States
(12) Patent Application Publication
(10) Pub. No.: US 2006/0250316 A1
(43) Pub. Date: Nov. 9, 2006

(54) Selectable subreflector configurations for antenna beam reconfigurability

(75) Inventors: Terry McCrea Smith, La Honda, CA (US); Karl Robert Claussing, San Carlos, CA (US); Jack Li Yi, Hayward, CA (US)

Correspondence Address: SPACE SYSTEMS/LORAL, INC., 3825 FABIAN WAY, M/S A-09, PALO ALTO, CA, 94303, US

(73) Assignee: Space Systems/Loral, Inc., Palo Alto, CA (US)

(21) Appl. No.: 11/123,914

(22) Filed: May 6, 2005

(51) Int. Cl. H01Q 13/00

(52) U.S. Cl. 343/781 CA; 343/781 P

(57) ABSTRACT

An antenna system for producing selectively reconfigurable antenna beam coverage patterns suitable for use in on an earth orbiting spacecraft is described. The system comprises a main reflector and a feed element with a subreflector module on which are disposed one or more subreflectors. The subreflector module is selectably positionable such that any one of the subreflectors may be disposed such that it is illuminated by the feed element and illuminates the main reflector. Each of the subreflectors has a shaped surface corresponding to a desired antenna beam coverage beam pattern. By appropriate selection from among the plurality of subreflectors, any one of a plurality of antenna beam coverage patterns can by provided with a single feed element and single main reflector.

### BACKGROUND OF THE INVENTION

1. Field of the Invention

This invention relates to multiple reflector antenna systems and methods for providing selectively reconfigurable antenna beam coverage patterns and, more particularly, to a reflector antenna system having a main reflector illuminated by a selected one of a plurality of subreflectors, and wherein each one of the plurality of subreflectors has a differently shaped surface contour so as to provide a different antenna beam coverage pattern, and wherein the plurality of subreflectors are mounted on a positioning mechanism providing the capability to reconfigure the antenna beam coverage pattern by changing the selected one of the plurality of subreflectors.

The assignee of the present invention manufactures and deploys communications satellites. The assignee's typical customer often is an operator of a fleet comprising multiple satellites operating in geosynchronous orbit. Some of the satellites in such a fleet can often be identical, except for different requirements for antenna beam coverage patterns. Requirements for antenna beam coverage patterns are largely predetermined by the longitude in geosynchronous orbit at which the satellite will operate and the service areas associated with that longitude. Because satellites have a long life and represent a significant capital investment, it is desirable to have the capability to use a given satellite at any of several longitudinal operating locations or to provide service from a single longitude selectively to different service areas. To meet this objective, a single satellite should have a flexible capability to provide a selectable plurality of antenna pattern coverage areas.

2. Description of the Related Art

Prior antenna systems providing a capability for reconfigurable antenna beam coverage patterns do so by use of active components that are inherently disadvantageous from the standpoint of reliability and cost and may provide less flexibility than the present invention. For example, U.S. Pat. No. 6,441,794, issued to Tang and Smith discloses use of a flat plate dual function subreflector and a subreflector positioning mechanism that selectively positions the subreflector so that any one of a plurality of feed arrays may illuminate the subreflector, which in turn illuminates the main reflector. A disadvantage of this prior system is that for each desired antenna beam coverage pattern, a separate feed array and appropriate switching electronics is required.

An alternate technique described in U.S. Pat. No. 5,949,370 issued to Smith and Marshburn discloses reconfiguration of antenna beam coverage patterns by mechanical reorientation of a reflector illuminated by an array of feed elements. The feed elements receive signals from a beam controller that adjusts the configuration of the beam by adjustment of the relative amplitudes and phases of the signals fed to each feed element. A disadvantage of this technique is that it requires multiple feed elements and expensive and complex electronics.

Another prior art technique described by Clarricoats, et. al. comprises a reconfigurable mesh reflector and feed array (see “An array-fed reconfigurable reflector for flexible coverage,” 23^{rd} European Microwave Conference, Madrid, September 1993 and “An array-fed mesh reflector for multiple spot beam and reconfigurable shaped beam operation,” IEE Colloquium on Hybrid Antennas, May 1993) wherein reconfiguration of the antenna beam coverage pattern is accomplished by mechanical adjustment of the reflector profile using a large number of precision stepper motors. The cost, complexity and reliability of these motors represent a deficiency that the present invention eliminates.

Still other methods of reconfiguring antenna beam pattern by way of active phased array antennas are known in the art and present similar difficulties with respect to cost and complexity.

Accordingly, it is an objective of the present invention to provide flexible reconfigurability of antenna beam coverage patterns while minimizing the number and complexity of active electronic and mechanical components.

### BRIEF SUMMARY OF THE INVENTION

The aforementioned objective is achieved and other advantages are provided by an antenna system, constructed in accordance with the invention, wherein the system includes a main reflector illuminated by at least one subreflector where one or more subreflectors may be selected from a plurality of differently shaped subreflectors, the plurality of subreflectors being mounted on at least one positioning mechanism, such that a desired antenna beam coverage pattern may be obtained by appropriate selection from the plurality of subreflectors.

An exemplary antenna system comprises a main reflector and at least one feed element. The feed element illuminates a selected one of a plurality of subreflectors and the selected subreflector illuminates the main reflector. Each of the plurality of subreflectors has a different surface contour shape for configuring the rays of radiation from the feed element into a beam of desired cross-sectional configuration corresponding to the desired antenna beam coverage pattern. The positioning mechanism provides for the positioning of any selected one of the plurality of subreflectors so that it is illuminated by the feed element and illuminates the main reflector. Preferably, the positioning mechanism is capable of multiple actuations so that the antenna beam coverage pattern may be changed from time to time as the satellite operator desires, and to facilitate system testing.

Although the foregoing description is directed toward a transmit antenna, it should be appreciated that the radiation pattern of an antenna is the same whether it is used as a transmitting antenna or a receiving antenna according to the reciprocity theorem of an antenna pattern and the present invention encompasses both transmit and receive antenna systems or combination transmit/receive antenna systems.

In accordance with a preferred embodiment of the invention, the surface contour of the main reflector is also shaped to optimize overall antenna system performance taking into account the surface contours of each of the plurality of subreflectors.

In a preferred embodiment of the invention, the main reflector is separately pivotable with respect to the subreflector, thereby providing additional capability to adjust the direction of the antenna beam pattern.

### BRIEF DESCRIPTION OF THE DRAWINGS

FIG. 1 illustrates an antenna system employing a plurality of subreflectors mounted on a positioning mechanism.

FIG. 2A shows antenna beam coverage pattern when an exemplary one of the plurality of subreflectors is selected.

FIG. 2B shows antenna beam coverage pattern when an exemplary second one of the plurality of subreflectors is selected.

### DETAILED DESCRIPTION OF THE INVENTION

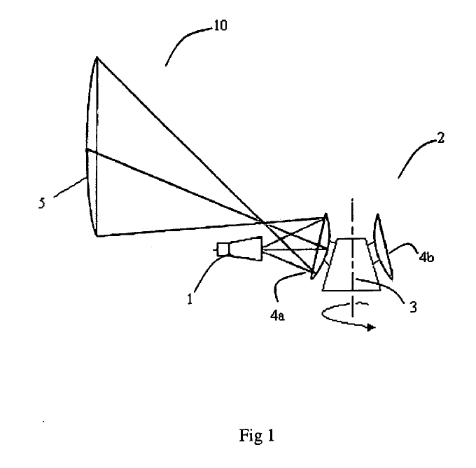

FIG. 1 shows an antenna system 10 employing an exemplary feed element 1, subreflector module 2 and main reflector 5 in accordance with the principles of the present invention. The subreflector module further comprises a plurality of subreflectors and a positioning mechanism 3. The mechanical configuration of the positioning mechanism is not relevant to this invention: it can be a rotary mechanism as shown in FIG. 1 or any other preferably simple, reliable mechanism known to those skilled in the art. By way of example, FIG. 1 illustrates an embodiment of the invention in which is provided two subreflectors, 4a and 4b, but it is to be understood that any number of subreflectors greater than one may be employed without departing from the principle of the present invention.

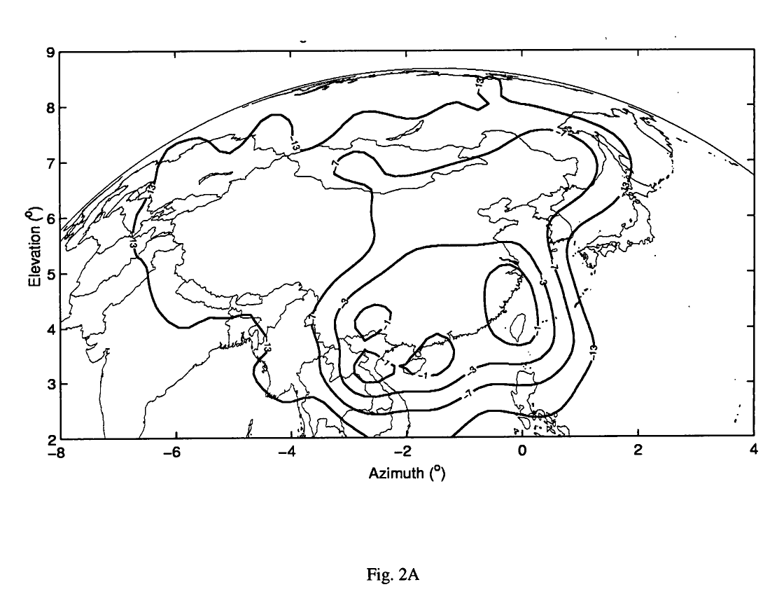

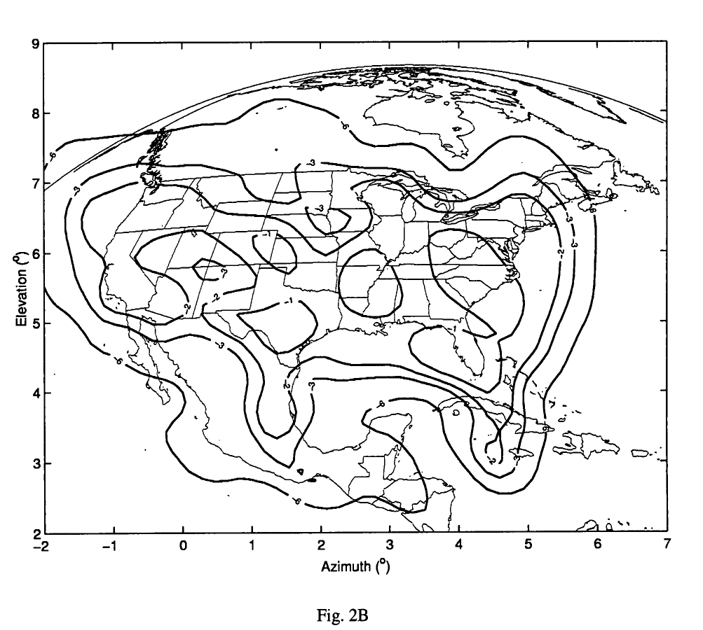

FIG. 2A illustrates an exemplary antenna beam coverage pattern provided when feed element 1 illuminates subreflector 4a which illuminates main reflector 5.

FIG. 2B illustrates an exemplary antenna beam coverage pattern provided when feed element 1 illuminates subreflector 4b which illuminates main reflector 5.

Comparing FIGS. 2A and 2B it is seen that distinctly different antenna beam coverage patterns may be achieved with a given main reflector and feed element by selecting one from among the plurality of shaped subreflectors so that the selected shaped subreflector is illuminated by the feed element and illuminates the main reflector.

During normal service, exactly one of the plurality of subreflectors 4, for example 4a, will be positioned so that it is illuminated by the feed element 1 and illuminates the main reflector 5. When a change in the antenna beam coverage pattern is desired because, for example, of a desired change in satellite orbital position, the positioning mechanism is actuated so as to position a different subreflector, for example 4b, so that it is illuminated by the feed element 1 and illuminates the main reflector 5. Thereby, a distinctly different antenna beam coverage pattern may be achieved with a single feed element and main reflector and without complex active electronic or mechanical elements.

It is to be understood that the above described embodiment of the invention is illustrative only, and that modifications thereof may occur to those skilled in the art. Accordingly, this invention is not to be regarded as limited to the embodiment disclosed herein, but is to be limited only as defined by the appended claims.

What is claimed is:

1. An antenna system for producing selectively reconfigurable antenna beam coverage patterns, comprising:
at least one feed element,
a main reflector,
at least one subreflector module which a plurality of subreflectors are disposed, said subreflector module further comprising:
a commandable positioning mechanism for positioning a selected subreflector from said plurality of subreflectors so that said selected subreflector is illuminated by said at least one feed element and illuminates said main reflector, and
wherein at least two of said plurality of subreflectors have differently shaped contours corresponding to at least two different antenna beam coverage patterns.

2. The antenna system of claim 1 wherein the said main reflector has a shaped contour.

3. The antenna system of claim 1 wherein the said main reflector is mechanically pivotable with respect to the subreflector.

4. An antenna system for producing selectively reconfigurable antenna beam coverage patterns, comprising:
at least one receiving element,
a main reflector
at least one subreflector module on of which a plurality of subreflectors are disposed, said subreflector module further comprising:
a commandable positioning mechanism for positioning a selected subreflector from said plurality of subreflectors so that said selected subreflector is illuminated by said main reflector and illuminates at least one said receiving element, and
wherein at least two said plurality of subreflectors have differently shaped contours corresponding to at least two different antenna beam coverage patterns.

5. The antenna system of claim 4 wherein the said main reflector has a shaped contour.

6. The antenna system of claim 4 wherein the said main reflector is mechanically pivotable with respect to the subreflector.

7. An antenna system for producing selectively reconfigurable antenna beam coverage patterns, comprising:
at least one combination transmit/receive element,
a main reflector
at least one subreflector module on which a plurality of subreflectors are disposed, said subreflector module further comprising:
a commandable positioning mechanism for positioning a selected subreflector from said plurality of subreflectors so that said selected subreflector is illuminated by said main reflector and illuminates at least one said receiving element, and
wherein at least two said plurality of subreflectors have differently shaped contours corresponding to at least two different antenna beam coverage patterns.

8. The antenna system of claim 7 wherein the said main reflector has a shaped contour.

9. The antenna system of claim 7 wherein the said main reflector is mechanically pivotable with respect to the subreflector.
